(19) United States
(12) Patent Application Publication
(10) Pub. No.: US 2026/0022869 A1
(43) Pub. Date: Jan. 22, 2026

(54) Test Chamber and Control Method

(71) Applicant: Weiss Technik GmbH, Reiskirchen (DE)

(72) Inventors: Yannik Zahrt, Rabenau (DE); Christian Haack, Marburg (DE)

(21) Appl. No.: 19/270,990

(22) Filed: Jul. 16, 2025

(30) Foreign Application Priority Data
Jul. 18, 2024 (EP) 24189420.3

(51) Int. Cl. F25B 9/00; F25B 6/04; F25B 9/10; G01N 17/00

(52) U.S. Cl. CPC F25B 9/008; F25B 6/04; F25B 9/10; G01N 17/002; F25B 2309/06; F25B 2400/0409

(57) ABSTRACT

A test chamber comprises a test space and a temperature control device for controlling the temperature thereof. A temperature of −20° C. to +180° C. is establishable within the test space by the temperature control device comprising a heating device and a cooling system. The cooling system has a cooling device and a heat exchanger disposed in the test space. The cooling device is realized with a cooling circuit with a refrigerant (CO₂), compressor, condenser, and expansion element. The heat exchanger connects to the cooling circuit. The test chamber has a control device for regulating the test space temperature, wherein the cooling system is realized with a second cooling device with a second cooling circuit with the refrigerant, second compressor, second condenser, and second expansion element. The heat exchanger connects to the second cooling circuit. The cooling devices are controllable by the control device as a function of the test space temperature.

### CROSS-REFERENCE TO RELATED APPLICATIONS

This patent application claims priority to European Patent Application No. 24189420.3 filed Jul. 18, 2025, the contents of which are incorporated herein by reference in its entity for all purposes.

### TECHNICAL FIELD

This disclosure relates to a test chamber, in particular a climate chamber for conditioning air, in particular a temperature control chamber, a climate chamber, or the like, and to a method for operating a test chamber, the test chamber comprising a test space for receiving test material, the test space being sealable against an environment and being temperature-insulated, and a temperature control device for controlling the temperature of the test space, a temperature in a temperature range of −20° C. to +180° C. being establishable within the test space by the temperature control device, the temperature control device comprising a heating device and a cooling system, the cooling system having a cooling device and a heat exchanger disposed in the test space, the cooling device being realized with a cooling circuit with a refrigerant, a compressor, a condenser, and an expansion valve, the heat exchanger being connected to the cooling circuit, the refrigerant being carbon dioxide, the test chamber having a control device for regulating the temperature in the test space.

### BACKGROUND

Test chambers of this kind are regularly used to test physical and/or chemical properties of objects, in particular devices. For example, there are known temperature test cabinets or climatic test cabinets within which temperatures in a range from −70° C. to +180° C. can be set. In the case of climatic test cabinets, desired climatic conditions can be additionally set, to which the device or the test material is then exposed over a defined period of time. The temperature of a test space containing the test material to be tested is regularly controlled in an air circulation duct within the test space. The air circulation duct forms an air treatment space in the test space, in which heat exchangers for heating or cooling the air flowing through the air circulation duct and/or the test space are disposed. A fan or a ventilator aspirates the air in the test space and guides it in the air circulation duct to the heat exchanger. The test material can thus be temperature-controlled or also exposed to a defined change in temperature. In this case, during a test interval, a temperature can, for example, change between a temperature maximum and a temperature minimum of the test chamber. A test chamber of this kind is known from EP 0 344 397 A2, for example.

The refrigerant used in a cooling circuit should have a relatively low CO₂ equivalent, i.e., a relative greenhouse potential or global warming potential (GWP) should be as low as possible in order to avoid indirect damage to the environment by the refrigerant upon release. It is therefore also known for carbon dioxide (CO₂) to be used as a pure-substance refrigerant. Carbon dioxide is available at low cost, is non-flammable and is essentially environmentally neutral with a GWP of 1. Carbon dioxide has a freezing temperature or a triple point of −56.6° C., which makes it impossible to achieve lower temperatures with carbon dioxide alone.

Since carbon dioxide as a refrigerant has a very high volumetric cooling capacity, a very high cooling capacity is provided by the cooling circuit even when using compressors with a very low stroke volume flow. In addition, a pressure range of cooling circuits with carbon dioxide as the refrigerant is very high (up to 120 bar) in transcritical operation, which is why the components required to form the cooling circuit are comparatively expensive. Due to the high pressure of an internal volume of the cooling circuit which is large in relation thereto, special safety requirements have to be met in addition.

Load fluctuations occur as a function of a temperature change in the test space such that the compressor is put into operation or put out of operation by the control device as needed. A standstill of the compressor sets in whenever a cooling of the test space is required or, for example, very high temperatures of up to +180° C. are to be established. If the temperature in the test space is then subsequently to be lowered to, for example, −20° C. in the course of a test cycle, a very large refrigeration capacity of the cooling system and/or the cooling device is required, in particular if the temperature is to be lowered within a short period of time. Furthermore, the temperature in the test space may also be lowered slowly or kept constant at a low level in the course of a test cycle. For this purpose, the compressor also has to be operated continuously, which is, however, difficult due to a dimensioning of the cooling system according to the maximally required refrigeration capacity and requires additional plant-specific effort. Thus, in this case, storage containers, internal heat exchangers, bypasses or the like can also be integrated into the cooling circuit. In addition, in this case, an energy consumption of the cooling device and/or the cooling system is always higher than it would have to be the case with the comparatively low refrigeration capacity.

### SUMMARY

Since test chambers are used for different application purposes, said test chambers can be of different sizes to receive particular products and, accordingly, also be realized with different refrigeration capacities. As a result, there is a need to produce test chambers at least in part individually for the respective application cases, in particular if an energy-efficient operation of the test chamber is to be guaranteed.

Hence, the object of the present disclosure is to propose a test chamber for conditioning air and a method for operating a test chamber which enable an inexpensive production and an inexpensive operation.

This object is attained by a test chamber having the features of described herein, a use of a module set having the features described herein and a method having the features described herein.

In the test chamber according to the disclosure for conditioning air, in particular temperature control chamber, climate chamber, or the like, the test chamber comprises a test space for receiving test material, the test space being sealable against an environment and being temperature-insulated, and a temperature control device for controlling the temperature of the test material, a temperature in a temperature range of −20° C. to +180° C. being establishable within the test space by the temperature control device, the temperature control device comprising a heating device and a cooling system, the cooling system having a cooling device and a heat exchanger disposed in the test space, the cooling device being realized with a cooling circuit with a refrigerant, a compressor, a condenser, and an expansion valve, the heat exchanger being connected to the cooling circuit, the refrigerant being carbon dioxide, the test chamber having a control device for regulating the temperature in the test space, wherein the cooling system is realized with a second cooling device with a second cooling circuit with the refrigerant, a second compressor, a second condenser, and a second expansion valve, the heat exchanger being connected to the second cooling circuit, the cooling devices being controllable by the control device as a function of the temperature in the test space

According to the disclosure, the intention is that the cooling system of the test chamber comprises at least two cooling devices. Both cooling devices are each realized with a cooling circuit with a refrigerant, a compressor, a condenser and an expansion valve. Carbon dioxide is used as a refrigerant in both cooling circuits. Both cooling circuits are connected to the heat exchanger which is located in the test space. In this case, the cooling circuits are not connected to each other. The control device is realized in such a manner that the cooling devices can be controlled by the control device as a function of the temperature in the test space. For example, if a high refrigeration capacity is required at the heat exchanger to establish a particular temperature in the test space, the control device can operate both cooling devices and/or their respective compressors parallel and/or at the same time. If only a low refrigeration capacity is required at the heat exchanger in the test space, the control device can operate only one of the cooling devices and/or their compressors and put the other cooling device and/or its compressor out of operation. A refrigeration capacity or cooling capacity (W) results from the product of an area (m²) of the heat exchanger, a heat transfer coefficient

$$( \frac{W}{m 2} \times K )$$

and a temperature difference (K).

Compared to one single cooling device of a test chamber, an internal volume of the respective cooling circuits of the test chamber according to the disclosure is comparatively smaller. Thus, in this case, only a comparatively low quantity of refrigerant has to be circulated in the respective cooling circuit and it is no longer necessary to provide structural measures in the cooling circuit in order to reduce the refrigeration capacity at the heat exchanger in the test space, as for example storage containers or the like. Therefore, the respective cooling circuits can be designed to be technically simpler overall. In contrast, in the cooling devices known from the state of the art, refrigerant has to flow through the entire internal volume of the cooling circuit in order to ensure an oil transport for lubricating the compressor even at a partial load and/or a low required refrigeration capacity. Therefore, a refrigeration capacity of the cooling circuit cannot be lowered readily by reducing a volume flow rate of the refrigerant.

It is true that two cooling devices are installed when producing the test chamber, but they are designed in a less complex manner. Due to the proportionally smaller internal volume per cooling device, a ratio of the pressure of the refrigerant in the cooling circuit and the internal volume changes, as a result of which fewer safety requirements for the cooling circuit have to be met. Moreover, a leak at the cooling circuit does not put out of operation the entire cooling system such that the cooling device can continue to be operated with the cooling circuit which is still intact. Furthermore, an energy saving results since, in the case at hand, only a comparatively smaller, single compressor has to be operated which circulates the lower quantity of refrigerant. On the whole, energy and costs can be saved over a longer operating period of the test chamber.

Lines of the cooling circuits of the respective cooling devices may run independently of each other through the heat exchanger. In this case, the respective cooling circuits are not materially connected to each other and are realized separately from each other. In this case, the lines of the cooling circuits can all be connected to the heat exchanger, but run separately from each other within the heat exchanger. The lines can be disposed in the heat exchanger in such a manner that they run in different sections of the heat exchanger and realize areas and/or partial surfaces of the heat exchanger which can be assigned to the respective cooling circuit. Alternatively, the lines may run, for example, parallel through the entire heat exchanger such that an entire surface of the heat exchanger can be used by each of the cooling devices.

The cooling system may be realized with another cooling device with another cooling circuit with the refrigerant, another compressor, another condenser, and another expansion valve, the heat exchanger being connected to the other cooling circuit. Consequently, the cooling system can have three, four, five, six or also more cooling devices, which are all connected to the heat exchanger with their respective cooling circuit. This makes it possible to combine a number of cooling devices according to a required refrigeration capacity of the test chamber in such a manner that the desired refrigeration capacity can be achieved. Furthermore, in this case, the control device can operate only one cooling device, two or more cooling devices and all cooling devices as a function of a temperature and/or capacity requirement as needed.

The heat exchanger may be realized only with one exchanger body. In this case, respective lines of the cooling circuit can run through the exchanger body. Depending on the arrangement of the lines in the exchanger body, it is, in this case, also possible to use a surface area of the exchanger body, which is effective for controlling the temperature, fully or partially with the respective line of the respective cooling circuit such that a dynamic change of the temperature in the test space can occur even with a comparatively small temperature difference of the exchanger body and the temperature in the test space. It is essential that the exchanger body be connected to the respective cooling circuit directly downstream of the respective expansion valve in such a manner that only refrigerant flowing via the expansion valve is conducted through the exchanger body. In this context, an exchanger body is understood to be a body that can be composed of one or more parts, for example, and through which the refrigerant flows. This also includes line arrangements that are provided with fins for better heat transfer. In this case, the fins form the exchanger body together with the line arrangement(s). In this case, the exchanger body has a surface area effective for heat transfer.

Each cooling device may be realized as an assembly having a support unit having a compressor, which is at least disposed thereon, a condenser, and an expansion valve. The assemblies can be constituted in such a manner that it is possible to modularly design the cooling system from the assemblies. The support unit can be a frame, a plate, a housing, or the like, the support unit being constituted in such a manner that the compressor, the condenser and the expansion valve can be simply mounted on the support unit and connected via the cooling circuit. Furthermore, a number of valves, fans of the condenser, bypasses of the cooling circuit, an internal heat exchanger, electrical connection lines, sensors and other electric and/or electronic components can be disposed on the support unit. The modular assembly can be realized as a cooling device functioning on its own, apart from the heat exchanger, which needs no other attachments. In this case, the cooling system can particularly simply be composed of at least two cooling devices and/or assemblies. In this case, to produce the cooling system, it is then merely required to connect the assemblies and/or respective lines of the cooling circuits to the heat exchanger.

The test chamber may be realized with a machine room which is spatially separated from the test space, wherein the cooling devices may be disposed in the machine room. If each cooling device is realized as an assembly, the cooling devices can be disposed particularly easily in the machine room. In this case, the test chamber can accommodate the cooling devices in a housing of the test chamber. In this case, the machine room can already be designed in such a manner that a particular number of cooling devices can be disposed in the machine room. Depending on the desired refrigeration capacity of the test chamber, the machine room can then be accordingly equipped with cooling devices. In this case, an empty space, which can be filled by a subsequent mounting of a cooling device if a higher refrigeration capacity is desired at a later point in time, can also remain partially in the machine room.

The cooling devices may be of the same design or designed differently from each other. Depending on the desired refrigeration capacity or use of the test chamber, cooling devices which have the same refrigeration capacity and can, in this case, be identical or cooling devices which have a different refrigeration capacity can be combined to form the cooling system. If at least three cooling devices are provided, two cooling devices can be of the same design and one cooling device can be designed differently, for example. Due to the same design or also modular design of cooling devices with a different refrigeration capacity, constructing and producing a cooling device individually for an application case of the test chamber is no longer required. In this case, it is advantageous that a number of cooling devices can be prefabricated and kept in a warehouse such that, when a customer orders a test chamber, it can be particularly easily mounted and delivered. For this purpose, in this case, it is merely required to put together the already existing cooling devices in such a manner that the desired cooling system is realized. Moreover, these cooling devices can be produced particularly cost-effectively in a standardized manner in series production.

The cooling devices may be realized with a refrigeration capacity in a range of 1 to 20 KW. For example, one cooling device can have a refrigeration capacity of 1 kW and a second cooling device can have a refrigeration capacity of 20 kW, which form together the cooling system. Cooling devices having different refrigeration capacities within the range can also be used. In this case, the cooling device having a low refrigeration capacity can be operated when only a very low refrigeration capacity is needed, for example in order to keep a temperature in the test space constant. The cooling device having a high refrigeration capacity and/or both cooling devices can be operated when a quick temperature change from a high temperature in the test space to a low temperature is to be carried out.

At least the cooling circuit may be realized with a low-pressure compressor and a high-pressure compressor downstream of the low-pressure compressor in a flow direction of the refrigerant. In principle, all cooling devices of the cooling system can be realized in such a manner. In this case, the cooling device can be configured as a so-called booster system. In this case, in the cooling circuit of the cooling device, the high-pressure compressor is connected in series downstream of the low-pressure compressor, so that the refrigerant is compressed in stages with the low-pressure compressor and then with the high-pressure compressor. Alternatively, the compressor can be a single two-stage compressor. Due to temperature changes in the test space, fluctuations can occur in a load requirement in the course of a test cycle. In this case, the low-pressure compressor may be operated together with the high-pressure compressor or just the high-pressure compressor alone. This is possible when the cooling circuit has a valve device by which the refrigerant can be conducted to the low-pressure compressor or to the high-pressure compressor. The valve device can be realized, for example, by a 3-way valve which allows for refrigerant to be fed either to the low-pressure compressor or to the high-pressure compressor. The valve device can be easily actuate by the control device. This makes it possible to vary each individual cooling device of the cooling system within limits with regard to a refrigeration capacity. On the whole, thus, the cooling system can be adjusted even better to a refrigeration capacity requirement.

A temperature in a temperature range of −40° C. to +180° C., preferably −55° C. to +180° C., can be established within the test space by the temperature control device.

The refrigerant may be pure carbon dioxide. Pure carbon dioxide has a GWP of 1, is non-flammable, non-hazardous and available at low cost. In addition, carbon dioxide is a pure substance or azeotropic, which enables an advantageous operation of the test chamber. Advantageously, carbon dioxide is used as the refrigerant in each of the cooling circuits. In this case, the respective cooling circuits may be operated in a thermodynamically transcritical state or in a subcritical state. Depending on the cooling load requirement within the test space, the operating state can be changed accordingly using the control device.

The temperature control device may comprise a heating device having a heater and a heating heat exchanger in the test space. For example, the heating device can be an electrical resistance heater that heats the heating heat exchanger in such a manner that an increase in temperature in the test space is made possible via the heating heat exchanger. If the heat exchanger and the heating heat exchanger can be controlled and/or regulated in a targeted manner by the control device to cool or heat the air circulated in the test space, a temperature in the temperature range specified above can then be established within the test space by the temperature control device.

When the disclosure intends the use of a module set having at least three cooling devices for producing a test chamber according to the disclosure, the module set comprises at least two cooling devices of the same design and/or an identical design and at least one cooling device which is designed differently therefrom, at least two cooling devices being selected from the module set for producing the test chamber. The module set can also comprise a number of further cooling devices which are designed identically or differently. The module set allows a selection to be made from these identically and/or differently designed cooling devices in order to realize the cooling system of the test chamber according to the disclosure. The selection can be carried out in such a manner that a desired refrigeration capacity is achieved. Furthermore, when selecting, it can also be taken into account the extent to which comparatively large refrigeration capacities are needed for a quicker temperature change and comparatively small refrigeration capacities are needed in order to keep a constant temperature in the test space within a test sequence. Further advantageous embodiments of a use are apparent from the descriptions of features of the dependent claims.

In the method according to the disclosure for operating a test chamber for conditioning air, in particular a temperature control chamber, a climate chamber, or the like, the test chamber has a test space for receiving test material, the test space being sealable against an environment and being temperature-insulated, the temperature of the test space being controlled by a temperature control device of the test chamber, a temperature in a temperature range of −20° C. to +180° C. being established within the test space by the temperature control device, the temperature control device comprising a heating device and a cooling system, the cooling system having a cooling device and a heat exchanger disposed in the test space, the cooling device being realized with a cooling circuit with a refrigerant, a compressor, a condenser, and an expansion valve, the heat exchanger being connected to the cooling circuit, the refrigerant being carbon dioxide, a control device of the test chamber regulating the temperature in the test space, wherein the cooling system is realized with a second cooling device with a second cooling circuit with the refrigerant, a second compressor, a second condenser, and a second expansion valve, the heat exchanger being connected to the second cooling circuit, the cooling devices being controlled by the control device as a function of the temperature in the test space. Regarding the advantages of the method according to the disclosure, reference is made to the description of advantages of the test chamber according to the disclosure.

The control device may operate the respective cooling devices as a function of a refrigeration capacity required to achieve the temperature in the test space. For this purpose, the control device can operate the cooling devices together or on their own alone. In this case, at least one of the cooling devices can be put out of operation by the control device. Since, in this case, a smaller volume of refrigerant has to be circulated overall, energy can be saved.

Other embodiments of the method are apparent from the descriptions of features of the dependent claims.

### BRIEF DESCRIPTION OF THE FIGURES

Hereinafter, preferred embodiments are explained in more detail with reference to the accompanying drawings.

In the figures:

FIG. 1 shows a schematic illustration of an embodiment of a cooling device;

FIG. 2 shows a perspective view of another embodiment of a cooling device;

FIG. 3 shows a schematic illustration of a test chamber having a cooling system.

### DETAILED DESCRIPTION

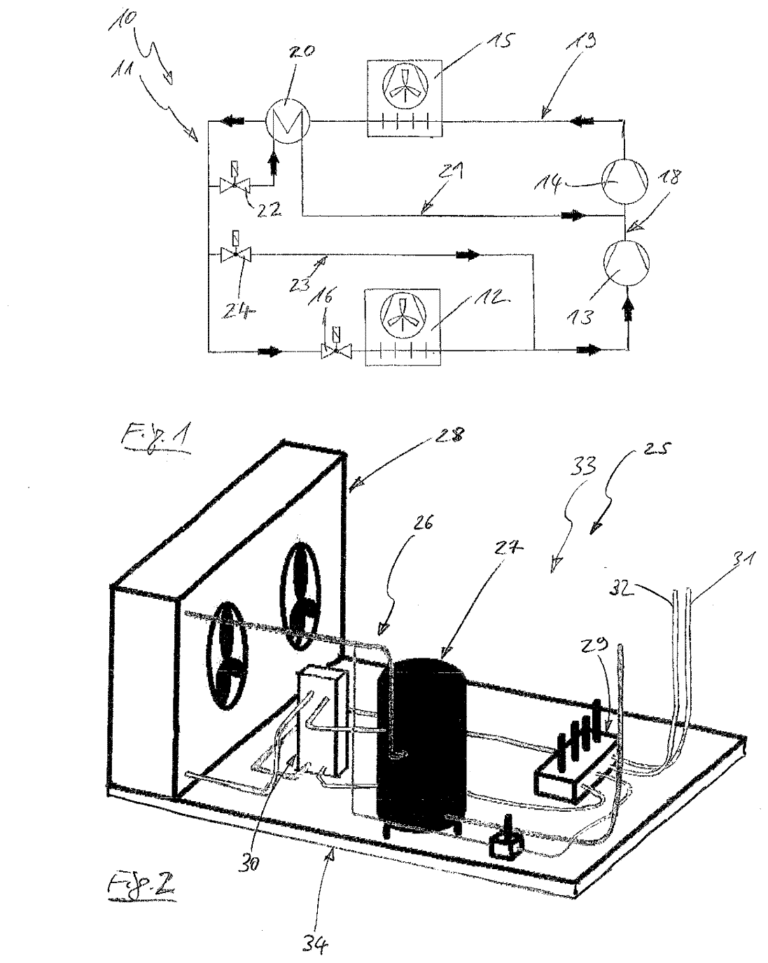

FIG. 1 shows a possible embodiment of a cooling device 10 of a cooling system of a test chamber (not illustrated in the case at hand). In this case, the cooling system has at least two cooling devices (not shown in the case at hand). Cooling device 10 comprises a cooling circuit 11 with carbon dioxide (CO₂) as a refrigerant, a heat exchanger 12, a low-pressure compressor 13, a high-pressure compressor 14, a condenser 15 and an expansion valve 16. In the case at hand, heat exchanger 12 is part of the cooling system (not illustrated) of the test chamber. In the case at hand, condenser 15 is configured in the manner of a heat exchanger or gas cooler and is cooled by a heat transfer medium, such as air or water. Heat exchanger 12 is disposed in an air treatment duct (not illustrated in the case at hand) of a test space of the test chamber in such a manner that air in the test space circulated via the air treatment duct can be cooled by heat exchanger 12. Furthermore, cooling circuit 11 has a low-pressure side 17, a medium-pressure side 18 and a high-pressure side 19. In low-pressure side 17, a pressure of the refrigerant is comparatively lower than in medium-pressure side 18. In medium-pressure side 18, a pressure of the refrigerant is comparatively lower than in high-pressure side 19.

Cooling circuit 11 further has an internal heat exchanger 20 downstream in a flow direction of the refrigerant and a medium-pressure bypass 21 upstream of expansion valve 16, said medium-pressure bypass 21 ending downstream of low-pressure compressor 13 and upstream of high-pressure compressor 14. A medium-pressure valve 22 is disposed in medium-pressure bypass 21. In this case, medium-pressure valve 22 is connected upstream of internal heat exchanger 20. Essentially partially liquid refrigerant can now be conducted upstream of condenser 15 through high-pressure side 19 of internal heat exchanger 20 and, if required, metered into medium-pressure side 18 of internal heat exchanger 20 via medium-pressure valve 22. In this case, the refrigerant of high-pressure side 19 is subcooled to such an extent that an even lower temperature can be established at expansion valve 16 and/or heat exchanger 12. At the same time, the refrigerant flowing via medium-pressure bypass 21 can be used to keep a suction-gas temperature of high-pressure compressor 14 comparatively low.

Moreover, cooling circuit 11 comprises a second bypass 23 having a second bypass valve 24. Second bypass 23 is connected to cooling circuit 11 downstream of internal heat exchanger 20 and upstream of expansion valve 16 in the flow direction of the refrigerant and downstream of heat exchange 12 and upstream of low-pressure compressor 13. Liquid refrigerant can be conducted to low-pressure side 17, past expansion valve 16 and heat exchanger 12, by second bypass valve 24. This makes it possible to regulate a suction-gas temperature and/or a suction-gas pressure in low-pressure side 17 upstream of low-pressure compressor 13. Cooling device 10 can be regulated by a control device (not illustrated) of the test chamber and sensors, in particular pressure and temperature sensors, located in cooling circuit 11.

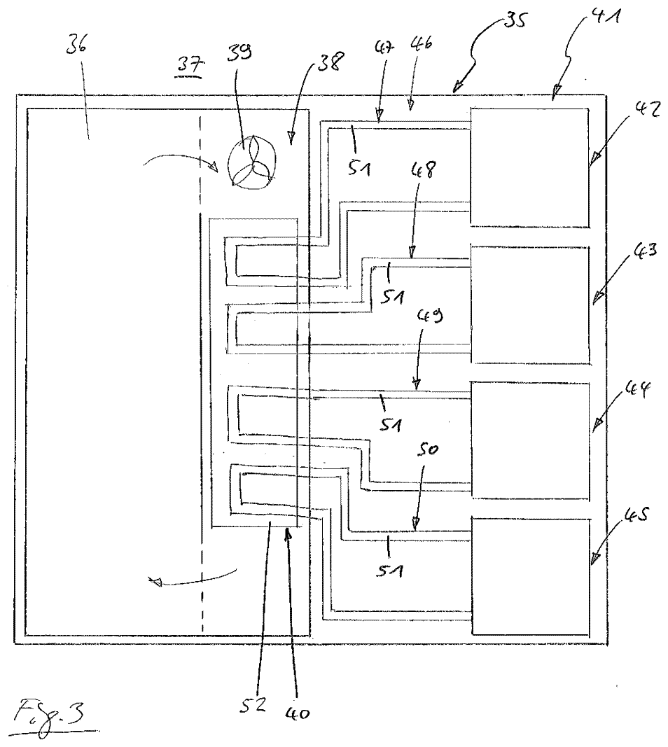

FIG. 2 shows a perspective view of a cooling device 25 in the manner of the cooling device of FIG. 1. In the case at hand, cooling device 25 is also composed of a cooling circuit 26 with a refrigerant, in particular carbon dioxide, a compressor 27, a condenser 28 and/or gas cooler, and an expansion valve 29. Cooling device 25 is part of a cooling system of a test chamber (not illustrated in the case at hand). In this case, the cooling system has at least one second cooling device (not shown in the case at hand). Cooling device 25 has an internal heat exchanger 30. Lines 31 and 32 serve to be connected to a heat exchanger (not illustrated in the case at hand) located in a test space of the test chamber. In the case at hand, cooling device 25 is realized as a modular assembly 33 having a support unit 34, wherein compressor 27, condenser 28, expansion valve 29 and internal heat exchanger 30 are firmly mounted on support unit 34. Compressor 27 can also be realized by a low-pressure compressor and a high-pressure compressor. Thus, assembly 33 can be pre-mounted in the manner of an intermediate product. In this case, it is merely necessary to connect assembly 33 to a heat exchanger (not shown in the case at hand) of the cooling system via lines 31 and 32 for the integration within a test chamber.

FIG. 3 shows a schematic illustration of a test chamber 35 having a test space 36 which is tightly sealed against an environment 37. An air circulation duct 38 is realized within test space 36, wherein air located in test space 36 can be circulated through said air circulation duct 38. This is carried by a fan 39 in air circulation duct 38. A heat exchanger 40 of a cooling system 41 is disposed within air circulation duct 38. Cooling system 41 is composed of cooling devices 42, 43, 44 and 45. Cooling devices 42, 43, 44 and 45 are disposed in a machine room 46 of test chamber 35. However, they also may be disposed outside of machine room 46. Cooling circuits 47, 48, 49 and 50 of cooling devices 42, 43, 44 and 45, respectively, are connected to heat exchanger 40 via a line 51.

Heat exchanger 40 is realized by an exchanger body 52. Lines 51 or cooling circuits 47, 48, 49 and 50 each run independently of each other and in a materially separated manner through exchanger body 52. Depending on which refrigeration capacity is required within test space 36, cooling device 42, 43, 44 and/or 45 can now be operated or put out of operation by a control device (not illustrated in the case at hand) of the test chamber. Heat exchanger 40 is then cooled partially or fully. Cooling devices 42, 43, 44 and 45 can be designed identically and/or differently from each other with the same or different refrigeration capacities. Depending on a requirement of a refrigeration capacity in test space 36, the control device can then put the respectively suitable cooling device 42, 43, 44 or 45 into operation or out of operation.

1. A test chamber for conditioning air, the test chamber comprising a test space for receiving test material, the test space being sealable against an environment and being temperature-insulated, and a temperature control device for controlling the temperature of the test space, a temperature in a temperature range of −20° C. to +180° C. being establishable within the test space by the temperature control device, the temperature control device comprising a heating device and a cooling system, the cooling system having a cooling device, and a heat exchanger disposed in the test space, the cooling device being realized with a cooling circuit with a refrigerant, a compressor, a condenser, and an expansion valve, the heat exchanger being connected to the cooling circuit, the refrigerant being carbon dioxide (CO₂), the test chamber having a control device for regulating the temperature in the test space,
wherein
the cooling system is realized with a second cooling device with a second cooling circuit with the refrigerant, a second compressor, a second condenser, and a second expansion valve, the heat exchanger being connected to the second cooling circuit, the cooling devices being controllable by the control device as a function of the temperature in the test space.

2. The test chamber according to claim 1,
wherein
lines of the cooling circuits of the respective cooling devices run independently of each other through the heat exchanger.

3. The test chamber according to claim 1,
wherein
the cooling system is realized with another cooling device with another cooling circuit with the refrigerant, another compressor, another condenser, and another expansion valve, the heat exchanger being connected to the other cooling circuit.

4. The test chamber according to claim 1,
wherein
the heat exchanger is realized with only one exchanger body.

5. The test chamber according to claim 1,
wherein
each cooling device is realized as an assembly having a support unit having a compressor, which is at least disposed thereon, a condenser, and an expansion valve.

6. The test chamber according to claim 1,
wherein
the test chamber is realized with a machine room which is spatially separated from the test space, the cooling devices being disposed in the machine room.

7. The test chamber according to claim 1,
wherein
the cooling devices being of the same design or designed differently from each other.

8. The test chamber according claim 1,
wherein
the cooling devices are realized with a refrigeration capacity in a range of 1 to 20 KW.

9. The test chamber according to claim 1,
wherein
at least the cooling circuit is realized with a low-pressure compressor and a high-pressure compressor downstream of the low-pressure compressor in a flow direction of the refrigerant.

10. The test chamber according to claim 1,
wherein
a temperature in a temperature range of −40° C. to +180° C. is establishable within the test space by means of the temperature control device.

11. The test chamber according to claim 1,
wherein
pure carbon dioxide (CO₂) is used as the refrigerant.

12. The test chamber according to claim 1,
wherein
the temperature control device comprises a heating device having a heater and a heating heat exchanger in the test space.

13. A use of a module set having at least three cooling devices for producing a test chamber according to claim 1, the module set comprising at least two cooling devices of the same design and at least one cooling device which is designed differently therefrom, at least two cooling devices being selected from the module set for producing the test chamber.

14. A method for operating a test chamber for conditioning air, the test chamber having a test space for receiving test material, the test space being sealable against an environment and being temperature-insulated, the temperature of the test space being controlled by a temperature control device of the test chamber, a temperature in a temperature range of −20° C. to +180° C. being established within the test space by the temperature control device, the temperature control device comprising a heating device and a cooling system, the cooling system having a cooling device and a heat exchanger disposed in the test space, the cooling device being realized with a cooling circuit with a refrigerant, a compressor, a condenser, and an expansion valve, the heat exchanger being connected to the cooling circuit, the refrigerant being carbon dioxide (CO₂), a control device of the test chamber regulating the temperature in the test space,
wherein
the cooling system is realized with a second cooling device with a second cooling circuit with the refrigerant, a second compressor, a second condenser, and a second expansion valve, the heat exchanger being connected to the second cooling circuit, the cooling devices being controlled by means of the control device as a function of the temperature in the test space.

15. The method according to claim 14,
wherein
the control device operates the respective cooling devices as a function of a refrigeration capacity required to achieve the temperature in the test space.
